(19) United States
(12) Patent Application Publication
(10) Pub. No.: US 2005/0034269 A1
(43) Pub. Date: Feb. 17, 2005

(54) Damper

(75) Inventor: Naoto Jinbo, Yokohama-shi (JP)

Correspondence Address: HAUPTMAN KANESAKA & BERNER, Suite 300, 1700 Diagonal Road, Alexandria, VA, 22314, US

(73) Assignee: NIFCO INC.

(21) Appl. No.: 10/891,042

(22) Filed: Jul. 15, 2004

(30) Foreign Application Priority Data
Dec. 22, 2003 (JP) 2003-425024
Aug. 12, 2003 (JP) 2003-291936

(51) Int. Cl. E05F 3/04

(52) U.S. Cl. 16/51

(57) ABSTRACT

A damper includes a cylindrical housing; a rotor rotationally housed in the cylindrical housing; a biasing member for applying a biasing force to the rotor; viscous fluid filled in the cylindrical housing; and a spare winding setting device for setting the biasing force of the biasing member. When the rotor rotates, the rotation is damped by a shear resistance of the viscous fluid filled in the cylindrical housing. The damper may include an open position lock mechanism having a first engaging projection disposed on an inner circumferential surface of the cylindrical housing and a second engaging projection disposed on an outer circumferential surface of the rotor. The first and second engaging projections can engage or move over with each other.

### BACKGROUND OF THE INVENTION AND RELATED ART STATEMENT

The present invention relates to a damper wherein a biasing force for closing a door is accumulated in a biasing member such as a coil spring to thereby damp the door when the door is opened. In particular, the present invention also relates to a shaft-type damper attached to a door of an operation panel of an electronic instrument such as a television and including an open position locking mechanism for locking the door biased in a closing direction at a predetermined open position.

A conventional damper is structured such that a rotor is housed in a cylindrical housing with a bottom to be rotatable with respect to the housing by a biasing force of a biasing member, for example, a coil spring. A rotation of the rotor is damped by shear resistance of viscous fluid filled in the housing. The housing is attached to a main portion, and a portion of the rotor projecting from a cap of the housing is attached to a door. In a case that the door is biased in an open direction, when a lock of the door is released, an opening operation of the door is damped. In a case that the door is biased in a closing direction by the biasing member, when a hand is removed from the door, a closing operation of the door is damped.

In a damper disclosed in Japanese Patent Publication (Kokai) No. 07-238971, spare winding for setting a biasing force of a biasing member is carried out such that, after a cap is attached to a housing, a rotor is rotated with respect to the housing, so that the rotor moves in an axial direction and an engaging projecting portion provided to the rotor moves over an engaging projecting portion provided to the cap.

However, it is difficult to provide a large engaging margin between the engaging projection portions. Accordingly, when the biasing member has a large biasing force, the spare winding is unwound by the biasing force of the spare-wound biasing member, thereby making it difficult to use the biasing member with the large biasing force.

In a damper disclosed in Japanese Patent Publication (Kokai) No. 2000-120746, a spare winding for setting a biasing force of a biasing member is carried out such that, after a rotor is attached to a housing, the rotor is rotated with respect to the housing, so that a claw portion disposed at a portion corresponding to a cap of the rotor moves over an inner side of a claw portion disposed at an open end of the housing. Accordingly, if the portion of the rotor corresponding to the cap is welded to the housing, the spare winding can not be carried out.

The dampers disclosed in Japanese Patent Publications (Kokai) No. 07-238971 and No. 2000-120746 include projections for adjusting the biasing force to be accumulated in the coil spring as a biasing member. However, in a case that a door or lid is biased in the closing direction by the coil spring, the door can not be locked at a predetermined open position.

In view of the problems described above, an object of the present invention is to provide a damper including an open position locking mechanism capable of locking a door or lid at an open position.

Further objects and advantages of the invention will be apparent from the following description of the invention.

### SUMMARY OF THE INVENTION

According to a first aspect of the invention, a damper includes a cylindrical housing with a bottom; a rotor housed in the cylindrical housing to be rotatable relative to the housing; and a biasing member for biasing the rotor. The damper damps a rotation of the rotor with shear resistance of viscous fluid filled in the housing. A spare winding setting device is provided for setting a biasing force of the biasing member for rotating the rotor with respect to the housing before the rotor is set in the housing.

According to a second aspect of the invention, a damper includes a cylindrical housing with a bottom; a rotor housed in the cylindrical housing to be rotatable relative to the housing; and a biasing member for biasing the rotor. The damper damps a rotation of the rotor with shear resistance of viscous fluid filled in the housing. A portion to be engaged is disposed on one of the bottom of the housing and a leading end of the rotor facing the bottom, and an engaging portion is disposed on the other of the bottom of the housing and the leading end of the rotor facing the bottom, so that when the rotor rotates with respect to the housing, the engaging portion abuts against the portion to be engaged.

In the present invention, the spare winding setting device is provided for setting the biasing force of the biasing member for rotating the rotor with respect to the house before the rotor is set in the housing. Accordingly, the biasing force of the biasing member for rotating the rotor with respect to the housing can be set before the rotor is set in the housing. Accordingly, it is not necessary to move the rotor in the axial direction for setting the biasing force of the biasing member. As a result, the biasing member with a large biasing force can be used, and the spare winding setting device can be applied to a damper in which a cap is fixed to the housing.

In the present invention, the portion to be engaged is provided on one of the bottom of the housing and the leading end of the rotor facing the bottom, and the engaging portion is provided on the other of the bottom in the housing and the leading end of the rotor for abutting against the portion to be engaged by rotating the rotor with respect to the housing. Accordingly, the biasing force of the coil spring for rotating the rotor with respect to the housing can be set by setting the rotor in the housing in a state that the biasing force is accumulated in the coil spring and by allowing the engaging portion to abut against the portion to be engaged. Accordingly, it is not necessary to move the rotor in the axial direction in order to set the biasing force of the coil spring after the rotor is set in the housing. As a result, a coil spring with a strong biasing force can be employed, and the mechanism formed of the portion to be engaged and the engaging portion can be applied to a damper in which a cap is welded to the housing.

According to a third aspect of the invention, a shaft-type damper damps a rotation of a rotor housed in a bottomed cylindrical housing rotatably with respect to the housing by the shear resistance of a viscous fluid filled in the housing. An open position lock mechanism is formed of an engaging projection disposed on an inner circumferential surface of the housing and an engaging projection disposed on an outer circumferential surface of the rotor for engaging the engaging projection. When a rotating torque becomes higher than a predetermined value, the rotor can rotate in both directions with respect to the housing as one of the engaging projections moves over the other of the engaging projections.

According to a fourth aspect of the invention, a shaft-type damper damps a rotation of a rotor housed in a bottomed cylindrical housing rotatably with respect to the housing by the shear resistance of a viscous fluid filled in the housing. An open position lock mechanism is formed of an engaging projection disposed on an inner circumferential surface of the housing and an elastic engaging projection having a projection disposed on the rotor and projecting from an outer peripheral surface of the rotor for engaging the engaging projection. When the rotating torque becomes higher than a predetermined value, the rotor can rotate in both directions with respect to the housing as the projection moves over the engaging projection.

According to a fifth aspect of the invention, a shaft-type damper damps rotation of a rotor housed in a bottomed cylindrical housing rotatably with respect to the housing by the shear resistance of a viscous fluid filled in the housing. An open position lock mechanism is formed of an engaging projection disposed on an inner peripheral surface of the housing and an elastic engaging projection having an elastic piece extending in the circumferential direction and a projection provided on a leading end of the elastic piece in the circumferential direction and projecting from an outer circumferential surface of the rotor for engaging the engaging projection. When the rotating torque becomes higher than a predetermined value, the rotor can rotate in both directions with respect to the housing as the projection moves over the engaging projection through the elastic deformation of the elastic piece.

In the present invention, it is desirable that a biasing device is provided between the housing and the rotor for accumulating the biasing force for rotating the rotor in the predetermined direction with respect to the housing.

In the present invention, the open position lock mechanism is provided, so that the door or lid can be locked at a predetermined open position. In a case that the door or lid is biased in the closing direction by the biasing force of the coil spring, a desired operation or work can be carried out in a state that a hand is away from the door or lid and the door or lid is locked at the open position with the open position lock mechanism.

### BRIEF DESCRIPTION OF THE DRAWINGS

FIG. 1 is an exploded perspective view of a damper with a partial section according to an embodiment of the present invention;

FIG. 2 is a left side view of a housing shown in FIG. 1;

FIG. 3 is a sectional view taken along line 3-3 in FIG. 2;

FIG. 4 is a right side view of a rotor shown in FIG. 1;

FIG. 5 is a sectional view taken along line 5-5 in FIG. 4;

FIG. 6 is a front view of the damper formed of the respective parts shown in FIG. 1;

FIG. 7 is a front sectional view of the damper shown in FIG. 6; and

FIGS. 8(a) to 8(c) are explanatory sectional views showing an operation of the damper.

### DETAILED DESCRIPTION OF PREFERRED EMBODIMENTS

Hereunder, embodiments of the invention will be explained with reference to the accompanying drawings.

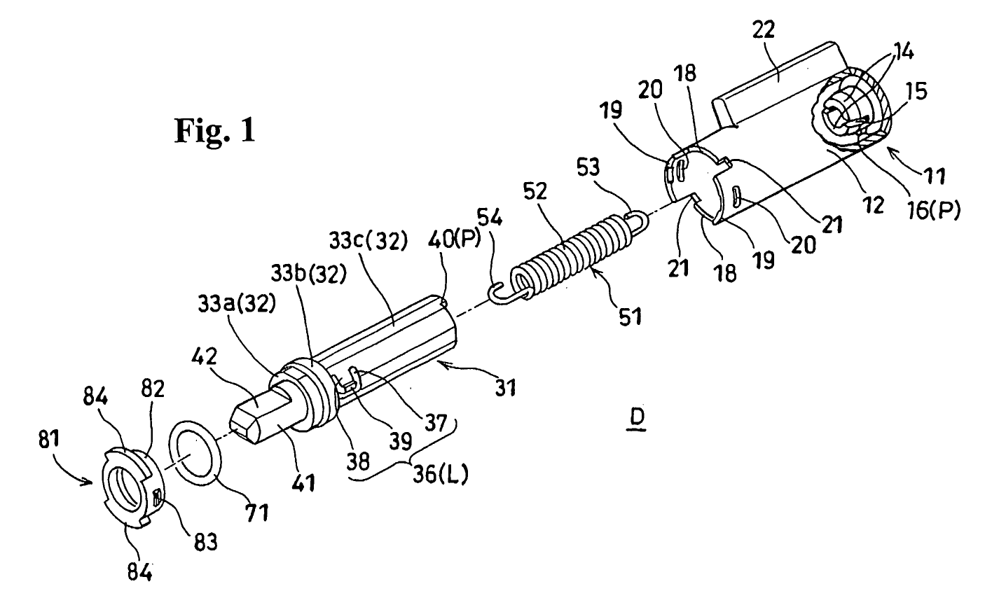

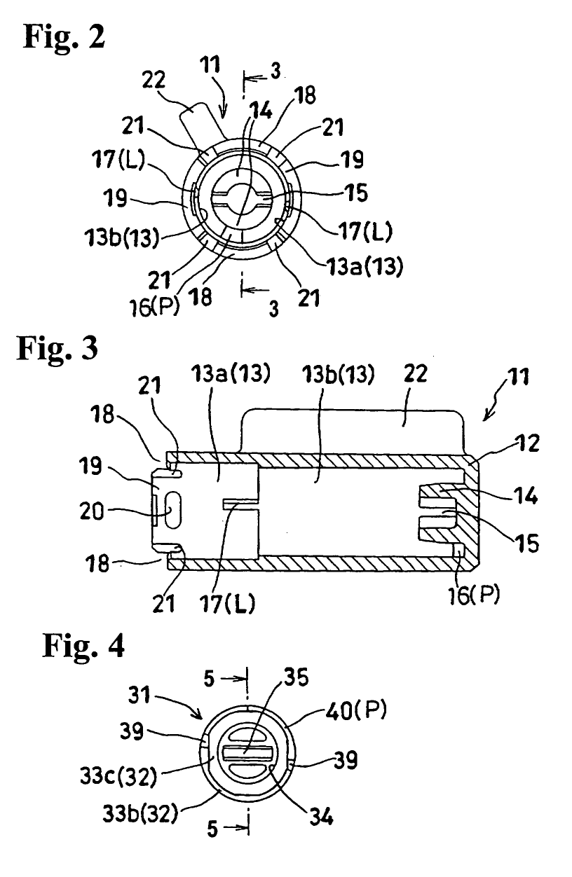

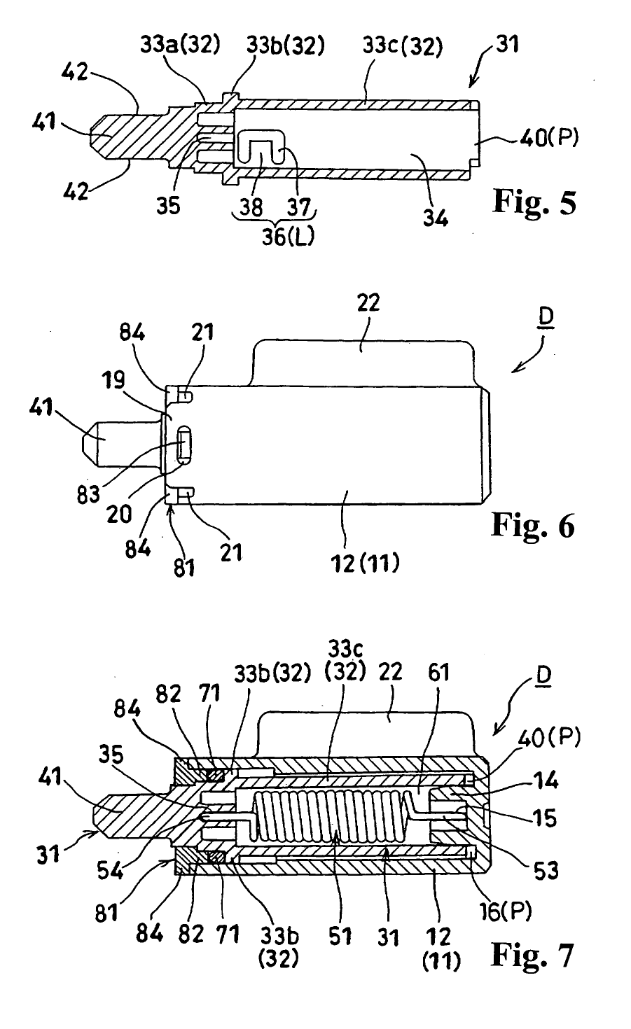

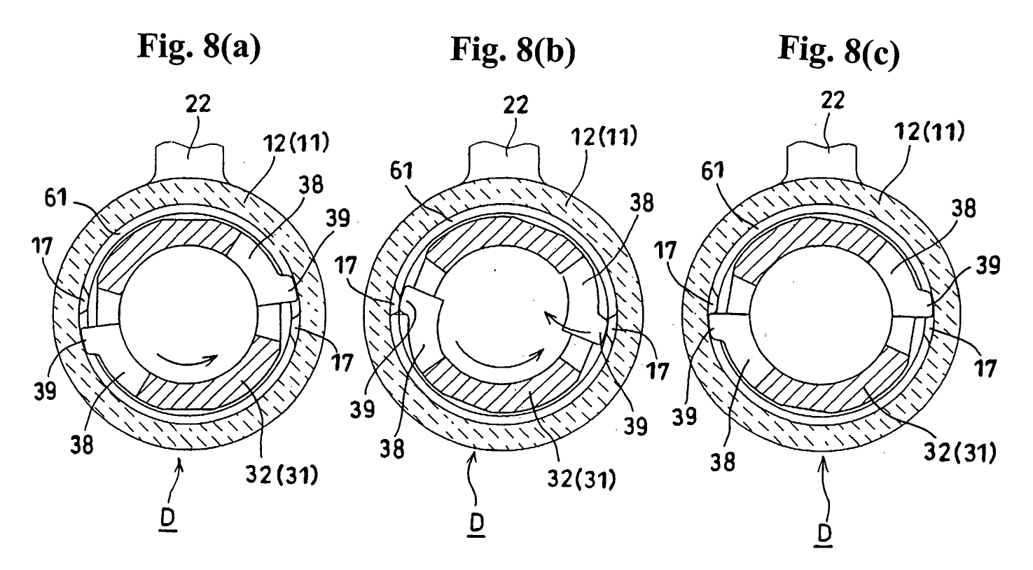

FIG. 1 is an exploded perspective view of a damper with a partial section according to an embodiment of the invention; FIG. 2 is a left side surface view of a housing shown in FIG. 1; FIG. 3 is a sectional view taken along line 3-3 in FIG. 2; FIG. 4 is a right side surface view of a rotor shown in FIG. 1; FIG. 5 is a sectional view taken along line 5-5 in FIG. 4; FIG. 6 is a front view of the damper formed of the parts shown in FIG. 1; FIG. 7 is a front sectional view of the damper shown in FIG. 6; and FIGS. 8(a) to 8(c) are views explaining an operation of the damper.

In FIG. 1, a damper D includes a housing 11; a rotor 31 having a part housed in the housing 11 and a part projecting from the housing 11; a coil spring 51 disposed between the housing 11 and the rotor 31 in an axial direction thereof as a biasing member for accumulating a biasing force to rotate the rotor 31 in a predetermined direction with respect to the housing 11; silicone oil 61 filled in the housing 11 as a viscous fluid; an O-ring 71 as a sealing member for sealing between the housing 11 and the rotor 31 to prevent the silicone oil 61 from leaking from the housing 11; and a cap 81 for preventing the O-ring 71 and the rotor 31 from coming out of the housing 11.

As shown in FIG. 1, the housing 11 is formed of a bottomed cylindrical portion 12 made of a synthetic resin and having a bottom end and an open end; and an engaging leg piece 22 integrally disposed on a periphery of the cylindrical portion 12 in an axial direction.

As shown in FIGS. 1 to 3, the bottomed cylindrical portion 12 includes a hole 13 formed of a larger diameter hole 13a positioned at the open end side and a smaller diameter hole 13b with a diameter smaller than that of the larger diameter hole 13a concentrically connected to the larger diameter hole 13a and reaching the bottom; a column-shape boss portion 14 positioned at the bottom center for rotatably fitting an open end of a bottomed cylindrical portion 32 of the rotor 31; an engaging groove 15 positioned along a diameter of the boss portion 14 for engaging a first engaging portion 53 on one end side of the coil spring 51 to be non-rotatable; a circular arc-shape portion to be engaged 16 disposed in a space between the bottomed cylindrical portion 12 and the boss portion 14 with a predetermined height in a predetermined angle area on the bottom of the bottomed cylindrical portion 12 (housing 11); two engaging projections 17 disposed on an inner peripheral surface of the larger diameter hole 13a at locations symmetrical to an axis and extending in an axial direction for a predetermined length; circular-arc concave portions 18 and circular-arc convex portions 19 alternatively positioned with an interval of 90 degrees therebetween on the open end side and having a concave or convex shape in an axial direction; slits 20 positioned on the respective circular-arc convex portions 19 and symmetrically extending in the peripheral direction; and isolating grooves 21 positioned on borders of the circular-arc concave portions 18 and the circular-arc convex portions 19 and extending toward the bottom side for a predetermined length.

Incidentally, a height (projection toward inside) of the engaging projection 17 is set such that an inner periphery thereof is flush with the peripheral surface of the smaller diameter hole 13b, as shown in FIG. 2.

As shown in FIGS. 1 and 5, the rotor 31 is formed of the bottomed cylindrical portion 32 made of a synthetic resin and having an open end; and a shaft portion 41 concentrically and integrally connected to a bottom of the bottomed cylindrical portion 32.

As shown in FIG. 5, the bottomed cylindrical portion 32 includes a smaller diameter portion 33a; a larger diameter portion 33b disposed concentrically with the smaller diameter portion 33a on the right side thereof for receiving an O-ring; and an intermediate diameter portion 33c disposed concentrically with the larger diameter portion 33b on the right side thereof. A cylindrical hole 34 extends from the right end of the intermediate diameter portion 33c to the larger diameter portion 33b.

As shown in FIGS. 4 and 5, on the bottom of the hole 34, there is provided an engaging groove 35 for engaging a second engaging portion 54 at the other end side of the coil spring 51 positioned on the diameter portion of the larger diameter portion 33b and reaching the right end proximity of the smaller diameter portion 33a. As shown in FIGS. 1, 4 and 5, an elastic engaging projection 36 is provided at a position of the intermediate diameter portion 33c corresponding to the engaging projection 17 of the housing 11. As shown in FIGS. 1, 4 and 5, an engaging portion 40 projecting in the axial direction is disposed to abut or slide the bottom of the bottomed cylindrical portion 12 of the housing 11 with about 120 degrees at the central angle for engaging the portion to be engaged 16 of the housing 11.

Incidentally, an outer periphery of the smaller diameter portion 33a and an inner periphery of the larger diameter hole 13a of the housing 11 are set in their diameters to have a space therebetween so that an O-ring 71 can be disposed therein. Also, an outer periphery of the larger diameter portion 33b and an inner periphery of the larger diameter hole 13a of the housing 11 are set in their diameters to have a little space therebetween.

As shown in FIGS. 1 and 5, the elastic engaging projection 36 is formed of an elastic piece 38 provided by forming a notched hole 37 in a shape of U-character opening in the circumferential direction on the intermediate diameter portion 33c; and projection (protrusion) 39 positioned on an outer peripheral surface of the leading end of the elastic piece 38 in the circumferential direction and projecting from the outer peripheral surface of the intermediate diameter portion 33c to extend in an axial direction of the intermediate diameter portion 33c for engaging the engaging projection 17 of the housing 11.

The two elastic engaging projections 36 are provided on axisymmetrical positions corresponding to the engaging projections 17 of the housing 11. As shown in FIGS. 1, 5 and 7, the shaft portion 41 is provided with parallel flat portions 42 formed in an I-cut shape. As shown in FIG. 1, the coil spring 51 is formed of a coil portion 52; the first engaging portion 53 provided on one end of the coil portion 52 and extending in an axial direction of the coil portion 52; and the second engaging portion 54 provided on the other end of the coil portion 52 and extending in the axial direction of the coil portion 52.

As shown in FIG. 1, a cap 81 includes a cylindrical portion 82 made of a synthetic resin and having an inner diameter for inserting the shaft portion 41 of the rotor 31 to be rotatable and an outer diameter for fitting the larger diameter hole 13a of the housing 11; engaging portions 83 integrally connected to the cylindrical position 82 and disposed at axisymmetrical positions on an outer peripheral surface of the cylindrical portion 82 for engaging the slit 20 in the peripheral direction of the housing 11; and a circular arc shape peripheral direction convex portion 84 projecting outwardly in the diameter direction for fitting the circular arc shape concave portion 18 of the housing 11 in a state that the circular arc circumferential direction convex portions 84 are located at axisymmetrical positions on the outer circumferential surface of the cylindrical portion 82 and the engaging portions 83 engage the slits 20 in the peripheral direction.

Incidentally, the outer diameters of the engaging portion 83 and the circular arc shape peripheral direction projection portion 84 are the same as that of the bottomed cylindrical portion 12 of the housing 11. In the embodiment, the spare winding setting mechanism (spare winding setting device) P is formed of the portion to be engaged 16 and the engaging portion 40. The open position lock mechanism L includes the engaging projection 17 and the elastic engaging projection 36.

An assembly of the damper D and the spare winding will be explained next. First, the housing 11 is put upright so that the open end of the bottomed cylindrical portion 12 becomes upwards and the first engaging portion 53 becomes downwards. The coil spring 51 is inserted into the hole 13 by allowing the first engaging portion 53 to correspond to the engaging groove 15. After the first engaging portion 53 engages the engaging groove 15, the silicone oil 61 is poured into the hole 13 for a predetermined quantity. Then, with the bottomed cylindrical portion 32 downwards, the engaging groove 35 corresponds to the second engaging portion 54 of the coil spring 51 to thereby insert the rotor 31 into the hole 13. When the rotor 31 is inserted into the hole 13, air inside the holes 13 and 34 goes out through the notched hole 37, and the second engaging portion 54 of the coil spring 51 engages the engaging groove 35.

In this state, for example, shown in FIG. 1, the rotor 31 rotates in the counter-clockwise direction with respect to the housing 11 to wind the coil spring 51. The rotor 31 is inserted into the hole 13 until the engaging portion 40 abuts against the bottom of the hole 13 after the biasing force of the coil spring 51 for rotating the rotor 31 with respect to the housing 11 is accumulated. Then, while the shaft portion 41 is inserted into the O-ring 71, the O-ring 71 is positioned between the bottomed cylindrical portion 12 and the bottomed cylindrical portion 32 so that the O-ring 71 abuts against the larger diameter portion 33b. At this time, the O-ring 71 is positioned below the isolating groove 21.

Next, while the shaft portion 41 is inserted into the cylindrical portion 82 with the engaging portion 83 downwards, the cap 81 is placed on the bottomed cylindrical portion 12 by allowing the circular arc shape circumferential direction convex portion 84 to correspond to the circular arc shape concave portion 18. When the cap 81 is pressed toward the bottomed cylindrical portion 12, the circular arc shape convex portion 19 expands by the action of the isolation groove 21. Accordingly, the circular arc shape circumferential direction convex portion 84 enters the circular arc shape concave portion 18, so that the engaging portion 83 is inserted into the circular arc shape convex portion 19.

Then, when the cylindrical portion 82 abuts against the O-ring 71, or presses and deforms the O-ring 71, the cylindrical portion 82 is lowered so that the engaging portion 83 faces the circumferential slit 20. Accordingly, the bottomed cylindrical portion 12 is restored to the original shape by its elasticity, so that the engaging portion 83 enters the circumferential slit 20 to engage. Thus, even if the pressing force to the cap 81 is released, the engaging portion 83 holds the engaging state with the circumferential slit 20, thereby assembling the damper D as shown in FIGS. 6 and 7.

When the damper D is assembled as described above, the coil spring 51 is unwound by the biasing force accumulated in the coil spring 51 by rotating the rotor 31 with respect to the housing 11 in the direction of winding up the coil spring 51 to thereby rotate the rotor 31. Then, the rotation of the rotor 31 is stopped when the engaging portion 40 of the rotor 31 abuts against the portion to be engaged 16 of the housing 11 to thereby set the biasing force of the spare winding. Therefore, in the state that the rotor 31 is set in the housing 11, the engaging portion 40 abuts against the portion to be engaged 16, thereby completing the spare winding.

A process of setting and adjusting the biasing force of the spring coil 51 will be explained next. In the assembled state of the damper D as described above shown in FIG. 8(a), when the rotor 31 is rotated in the counter-clockwise direction with respect to the housing 11, the projection 39 abuts against the engaging projection 17, so that the rotor 31 can not be rotated further in the counter-clockwise direction with respect to the housing 11.

As shown in FIG. 8(b), when the rotor 31 rotates in the counter-clockwise direction with the rotating torque corresponding to a force for elastically deforming the elastic piece 38 to move the projection 39 over the engaging projection 17, the elastic piece 38 is elastically deformed and the projection 39 moves over the engaging projection 17 to thereby rotate the rotor 31 in the counter-clockwise direction.

Incidentally, when the projection 39 moves over the engaging projection 17, the projection 39 is restored to the original state, i.e. a state where the projection 39 abuts against the engaging projection 17 with the elasticity of the elastic piece 38. Then, when the force for rotating the rotor 31 in the counter-clockwise direction is released under the state that the projection 39 moves over the engaging projection 17, the projection 39 abuts against the engaging projection 17 by the rewinding biasing force (for rotating the rotor 31 in the clockwise direction with respect to the housing 11) accumulated in the coil spring 51.

At this time, as described above, the biasing force of the coil spring 51 deforms the elastic piece 38 elastically. In a case that the biasing force is smaller than that to move the projection 39 over the engaging projection 17, the state that the projection 39 abuts against the engaging projection 17 is maintained by the operation of the open position locking mechanism L as shown in FIG. 8(c).

Incidentally, in a case that the rotor 31 is rotated in the clockwise direction with respect to the housing 11 to reduce the rewinding biasing force accumulated in the coil spring 51, the projection 39 moves over the engaging projection 17 by rotating the rotor 31 in the clockwise direction with the rotational torque corresponding to the force for elastically deforming the projection 39 to move the elastic piece 38 over the engaging projection 17.

In a case that the winding-in biasing force (for rotating the rotor 31 in the counter-clockwise direction with respect to the housing 11) is accumulated in the coil spring 51 by rotating the rotor 31 in the clockwise direction with respect to the housing 11, the same operation can be carried out.

Accordingly, the biasing force for rewinding or winding is accumulated in the coil spring 51 and can be adjusted by rotating the rotor 31 in the counter-clockwise direction or the clockwise direction with respect to the coil spring 51.

An operation of the damper will be explained next. Incidentally, it is assumed that the housing 11 is attached to the main portion of an electronic instrument not to rotate by using the engaging leg piece 22, the shaft portion 41 is attached to a door of the electronic instrument at the flat portion 42 to integrally rotate, the unwinding biasing force is accumulated in the coil spring 51, and the door is biased by the biasing force in the closing direction of the door with respect to the main portion. Also, it is assumed that, under the state that the door is closed, the positional relationship between the housing 11 and the rotor 31 is in a state as shown in FIG. 8(a).

First, in the state that the door is closed as shown in FIG. 8(a), when the door is rotated in the counter-clockwise direction by holding the rotating end (end away from the rotating center) of the door, the door can be opened around the damper D as a rotating center. As described above, when the door is opened, the coil spring 51 is wound up by rotating the rotor 31 in the counter-clockwise direction, and the unwinding biasing force is accumulated in the coil spring 51.

When the hand is removed from the door, since the unwinding biasing force is accumulated in the coil spring 51, the door is rotated in the clockwise direction by the biasing force to be closed. As described above, when the door is closed by the unwinding biasing force of the coil spring 51, since the bottomed cylindrical portion 32 of the rotor 31 rotating in the bottomed cylindrical portion 12 of the housing 11 is damped by the shear resistance of the silicone oil 61, the closing operation of the door is damped, so that the door is slowly closed.

In the state that the door is closed as shown in FIG. 8(a), when the projection 39 is tried to open more than an angle that the projection 39 abuts against the engaging projection 17 by holding the rotating end of the door, the projection 39 abuts against the engaging projection 17, so that the rotor 31 can not be rotated over the angle in the counter-clockwise direction with respect to the housing 11.

However, when the rotor 31 is rotated in the counter-clockwise direction by the rotary torque corresponding to the force that the projection 39 moves over the engaging projection 17 through the elastic deformation of the elastic piece 38 as shown in FIG. 8(b), the elastic piece 38 is elastically deformed and the projection 39 moves over the engaging projection 17, so that the rotor 31 is further rotated in the counter-clockwise direction. Incidentally, when the projection 39 moves over the engaging projection 17, the projection 39 is restored to the original state, i.e. a state where the projection 39 abuts against the engaging projection 17. Accordingly, the door can be opened over the angle that the projection 39 abuts against the engaging projection 17.

When the door is opened as described above, the coil spring 51 is wound up through the rotation of the rotor 31 in the counter-clockwise direction to accumulate the unwinding biasing force in the coil spring 51. Then, when the hand is removed from the door, since the unwinding biasing force is accumulated in the coil spring 51, the door is rotated in the clockwise direction by the biasing force and closed. As described above, when the door is closed by the unwinding biasing force of the coil spring 51, since the bottomed cylindrical portion 32 of the rotor 31 rotating in the bottomed cylindrical portion 12 of the housing 11 is damped by the shear resistance of the silicone oil 61, operation for closing the door is damped and the door is closed slowly.

As shown in FIG. 8(c), the unwinding biasing force of the coil spring 51 is not greater than the rotary torque that the projection 39 abuts against the engaging projection 17 and moves over the engaging projection 17. Accordingly, the door is locked at the open position by the open position locking mechanism L to thereby hold the opened state of the door. Incidentally, in the case that the door locked at the open position is closed, when the projection 39 moves over the engaging projection 17 by pushing the door with a hand, the door is slowly closed by the unwinding biasing force of the coil spring 51.

As described above, in the embodiments of the invention, the spare winding setting mechanism, i.e. the spare winding setting device P, is formed of the portion to be engaged 16 disposed on the bottom of the housing 11 and the engaging portion 40 disposed to the leading end of the rotor 31. Accordingly, the rotor 31 is set in the housing 11 in the state that the biasing force is accumulated in the coil spring 51 and the biasing force of the coil spring 51 rotating the rotor 31 with respect to the housing 11 can be set by allowing the engaging portion 40 to abut against the portion to be engaged 16.

Therefore, after the rotor 31 is set in the housing 11, it is not necessary to move the rotor 31 in the axial direction to set the biasing force of the coil spring 51. Thus, it is possible to use the coil spring 51 having strong biasing force, and the spare winding setting mechanism P formed of the portion to be engaged 16 and the engaging portion 40 can be applied to the damper in which a cap is welded to the housing.

Also, the open position locking mechanism L is provided for locking the door or lid at a predetermined position. Therefore, in the case that the door or lid is urged by the biasing force of the coil spring 51 in the closing direction, a desired operation and work can be carried out in the state that the hand is away from the door or lid by actuating the open position locking mechanism L so that the door or lid is locked at the open position.

In the embodiments, the portion to be engaged 16 is provided to the housing 11 and the engaging portion 40 is provided to the rotor 31. The same operation can be obtained when the portion to be engaged 16 is provided to the rotor 31 and the engaging portion 40 is provided to the housing 11.

Also, the elastic engaging projection 36 is disposed where the projection 39 is provided to the elastic piece 38. The same operation can be obtained by using both parts as engaging projections with elastic deformation of the bottomed cylindrical portions 12 and 32.

Further, the coil spring 51 is used as the biasing member, and other biasing member operating in the same manner may be employed. The silicone oil 61 is used as the viscous fluid, and other viscous fluid functioning in the same manner, such as grease, may be employed. The damper D with the cap 81 is used in the present embodiment, and the present invention can be applied to the damper without the cap.

The disclosures as disclosed in Japanese Patent Applications No. 2003-291936 filed on Aug. 12, 2003 and No. 2003-425024 filed on Dec. 22, 2003 are incorporated herein.

While the invention has been explained with reference to the specific embodiments of the invention, the explanation is illustrative and the invention is limited only by the appended claims.

1. A damper comprising:
a cylindrical housing,
a rotor rotatably housed in the cylindrical housing,
a biasing member situated between the cylindrical housing and the rotor for applying a biasing force to the rotor,
viscous fluid filled in the cylindrical housing, and
a spare winding setting device formed between the cylindrical housing and the rotor for setting the biasing force of the biasing member.

2. A damper according to claim 1, wherein said spare winding setting device includes a first engaging portion disposed on one of a bottom of the cylindrical housing and a leading end of the rotor facing the bottom of the cylindrical housing, and a second engaging portion disposed on the other of the bottom of the cylindrical housing and the leading end of the rotor for engaging the first engaging portion when the rotor rotates with respect to the cylindrical housing.

3. A damper according to claim 2, wherein said first engaging portion is an arc-shape projection projecting from the bottom of the cylindrical housing, and said second engaging portion is a projection projecting from the leading end of the rotor along an axis thereof.

4. A damper comprising:
a cylindrical housing,
a rotor rotatably housed in the cylindrical housing,
viscous fluid filled in the cylindrical housing, and
an open position lock mechanism having a first engaging projection disposed on an inner circumferential surface of the cylindrical housing and a second engaging projection disposed on an outer circumferential surface of the rotor for engaging the first engaging projection, one of said first and second engaging projections moving over the other of the first and second engaging projections when the rotor rotates with a rotating torque greater than a predetermined value so that the rotor rotates in both directions with respect to the cylindrical housing.

5. A damper according to claim 4, wherein said second engaging projection is formed of an elastic material projecting from the outer circumferential surface of the rotor for engaging the first engaging projection.

6. A damper according to claim 4, wherein said second engaging projection has an elastic piece extending in a circumferential direction and a projection formed at a forward end of the elastic piece in the circumferential direction and projecting from the outer circumferential surface of the rotor for engaging the first engaging projection.

7. A damper according to claim 4, further comprising a biasing device disposed between the cylindrical housing and the rotor for accumulating a biasing force for rotating the rotor in a predetermined direction with respect to the cylindrical housing.

8. A damper according to claim 4, further comprising a spare winding setting device formed between the cylindrical housing and the rotor for setting the biasing force of the biasing member.

9. A damper according to claim 8, wherein said spare winding setting device includes a first engaging portion disposed on one of a bottom of the cylindrical housing and a leading end of the rotor facing the bottom of the cylindrical housing, and a second engaging portion disposed on the other of the bottom of the cylindrical housing and the leading end of the rotor for engaging the first engaging portion when the rotor rotates with respect to the cylindrical housing.
